(19) United States
(12) Patent Application Publication
(10) Pub. No.: US 2023/0178858 A1
(43) Pub. Date: Jun. 8, 2023

(54) BUS BAR CONFIGURATIONS FOR CONNECTING BATTERY PACK COMPONENTS IN PARALLEL

(71) Applicant: FORD GLOBAL TECHNOLOGIES, LLC, Dearborn, MI (US)

(72) Inventors: Nihar KOTAK, Farmington Hills, MI (US); Daniel Paul ROBERTS, Livonia, MI (US); Francisco FERNANDEZ-GALINDO, Canton, MI (US)

(21) Appl. No.: 17/545,042

(22) Filed: Dec. 8, 2021

(51) Int. Cl. H01M 50/512; H01M 50/503; H01M 50/507

(52) U.S. Cl. CPC H01M 50/512; H01M 50/503; H01M 50/507; H01M 2220/20

(57) ABSTRACT

Exemplary bus bar assemblies may be used to electrically couple adjacent components of electrified vehicle traction battery packs, for example. An exemplary bus bar assembly may include a bus bar and a cover disposed about portions of the bus bar. The bus bar may include a single combined electrical interface section and multiple component electrical interface sections for connecting multiple traction battery pack electrical components in parallel configurations.

### TECHNICAL FIELD

This disclosure relates generally to electrified vehicle traction battery packs, and more particularly to bus bars assemblies configured for electrically coupling traction battery pack components in parallel configurations.

### BACKGROUND

Electrified vehicles are designed to reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage traction battery pack typically powers the electric machines and other electrical loads of the electrified vehicle. The traction battery pack includes a plurality of battery arrays that each include groupings of battery cells for powering the electric propulsion of electrified vehicles. Adjacent battery arrays must be reliably connected to one another in order to achieve the voltage and power levels necessary to propel the vehicle.

### SUMMARY

A battery pack according to an exemplary aspect of the present disclosure includes, among other things, a first electrical component, a second electrical component; and a bus bar assembly configured to electrically couple the first and second electrical components in a parallel configuration. The bus bar assembly includes a bus bar having a first component electrical interface connected to the first electrical component, and a second component electrical interface connected to the second electrical component.

In a further non-limiting embodiment of the foregoing battery pack, the first electrical component is a first battery array and the second electrical component is a second battery array.

In a further non-limiting embodiment of either of the foregoing battery packs, the bus bar assembly is configured to electrically couple the first electrical component, the second electrical component, and a third electrical component in the parallel configuration.

In a further non-limiting embodiment of any of the foregoing battery packs, the bus bar includes a third component electrical interface connected to the third electrical component.

In a further non-limiting embodiment of any of the foregoing battery packs, the first, second, and third electrical components are battery arrays.

In a further non-limiting embodiment of any of the foregoing battery packs, the bus bar includes a combined electrical interface.

In a further non-limiting embodiment of any of the foregoing battery packs, the combined electrical interface includes a first cross-sectional area that is larger than a second cross-sectional area of the first component electrical interface or a third cross-sectional area of the second component electrical interface.

In a further non-limiting embodiment of any of the foregoing battery packs, the combined electrical interface is connected to a high voltage output point of the battery pack.

In a further non-limiting embodiment of any of the foregoing battery packs, the bus bar assembly includes a cover that at least partially covers the bus bar, and the first component electrical interface and the second component electrical interface are each at least partially exposed for making an electrical connection.

In a further non-limiting embodiment of any of the foregoing battery packs, a second bus bar assembly is configured to electrically couple the first and second electrical components in the parallel configuration.

A battery pack according to another exemplary aspect of the present disclosure includes, among other things, a first string of battery arrays, a second string of battery arrays, and a bus bar assembly configured to electrically couple the first and second strings of battery arrays in a parallel configuration. The bus bar assembly includes a bus bar having a first component electrical interface connected to the first string of battery arrays and a second component electrical interface connected to the second string of battery arrays.

In a further non-limiting embodiment of the foregoing battery pack, the bus bar assembly includes a cover that at least partially covers the bus bar, and the first and second component electrical interfaces are at least partially exposed for making an electrical connection.

In a further non-limiting embodiment of either of the foregoing battery packs, a second bus bar assembly is configured to electrically couple the first and second strings of battery arrays in the parallel configuration.

In a further non-limiting embodiment of any of the foregoing battery packs, the bus bar assembly is electrically coupled to positive terminals of the first and second strings of battery arrays, and the second bus bar assembly is electrically coupled to negative terminals of the first and second strings of battery arrays.

In a further non-limiting embodiment of any of the foregoing battery packs, the bus bar assembly is further coupled to a high voltage positive output point of the battery pack, and the second bus bar assembly is further coupled to a high voltage negative output point of the battery pack.

In a further non-limiting embodiment of any of the foregoing battery packs, each of the first and second strings of battery arrays includes a plurality of battery arrays connected together in a series configuration.

In a further non-limiting embodiment of any of the foregoing battery packs, the bus bar includes a combined electrical interface.

In a further non-limiting embodiment of any of the foregoing battery packs, the combined electrical interface includes a first cross-sectional area that is larger than a second cross-sectional area of the first component electrical interface or a third cross-sectional area of the second component electrical interface.

In a further non-limiting embodiment of any of the foregoing battery packs, the bus bar assembly is configured to electrically couple the first string of battery arrays, the second string of battery arrays, and a third string of battery arrays in the parallel configuration.

In a further non-limiting embodiment of any of the foregoing battery packs, the battery pack is a component of an electrified vehicle.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery system of a traction battery pack.

FIG. 3 illustrates another exemplary battery system of a traction battery pack.

FIG. 4 illustrates an exemplary bus bar assembly for electrically coupling components of a traction battery pack in a parallel configuration.

FIG. 5 illustrates another exemplary bus bar assembly for electrically coupling components of a traction battery pack in a parallel configuration.

FIG. 6 illustrates another exemplary battery system of a traction battery pack.

FIG. 7 illustrates yet another exemplary battery system of a traction battery pack.

### DETAILED DESCRIPTION

This disclosure details exemplary bus bar assembly designs, such as those configured for electrically coupling adjacent components of electrified vehicle traction battery packs, for example. An exemplary bus bar assembly may include a bus bar and a cover disposed about portions of the bus bar. The bus bar may include a single combined electrical interface section and multiple component electrical interface sections for connecting multiple traction battery pack electrical components in parallel configurations. These and other features are discussed in greater detail in the following paragraphs of this detailed description.

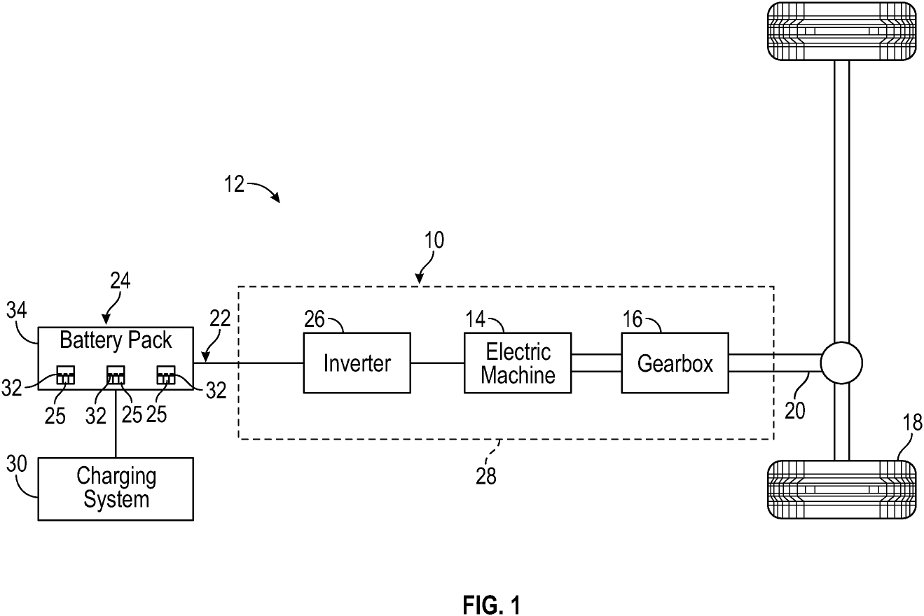

FIG. 1 schematically illustrates a powertrain 10 of an electrified vehicle 12. In an embodiment, the electrified vehicle 12 is a battery electric vehicle (BEV). However, it should be understood that the concepts described herein are not limited to BEVs and could extend to other electrified vehicles, including, but not limited to, hybrid electric vehicles (HEVs), plug-in hybrid electric vehicles (PHEVs), fuel cell vehicles, etc. Although not shown in this exemplary embodiment, the electrified vehicle 12 could be equipped with an internal combustion engine that can be employed either alone or in combination with other energy sources to propel the electrified vehicle 12.

In the illustrated embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output torque. The electric machine 14 may be connected to a gearbox 16 for adjusting the output torque and speed of the electric machine 14 by a predetermined gear ratio. The gearbox 16 is connected to a set of drive wheels 18 by an output shaft 20.

A voltage bus 22 electrically connects the electric machine 14 to a traction battery pack 24 through an inverter 26, which can also be referred to as an inverter system controller (ISC). The electric machine 14, the gearbox 16, and the inverter 26 may be collectively referred to as a transmission 28 of the electrified vehicle 12.

The traction battery pack 24 is an exemplary electrified vehicle battery. The traction battery pack 24 may be a high voltage traction battery pack that includes one or more battery arrays 25 (i.e., battery assemblies or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The one or more battery arrays 25 of the traction battery pack 24 may include a plurality of battery cells 32 that store energy for powering various electrical loads of the electrified vehicle 12. The traction battery pack 24 could employ any number of battery cells 32 within the scope of this disclosure. Accordingly, this disclosure should not be limited to the exact configuration shown in FIG. 1.

In an embodiment, the battery cells 32 are lithium-ion cells. However, other cell chemistries (nickel-metal hydride, lead-acid, lithium-ion phosphate, etc.) could alternatively be utilized within the scope of this disclosure.

In another embodiment, the battery cells 32 are cylindrical or prismatic battery cells. However, other cell geometries could alternatively be utilized within the scope of this disclosure.

An enclosure assembly 34 may house the battery arrays 25 of the traction battery pack 24. The enclosure assembly 34 may include any size, shape, and configuration within the scope of this disclosure.

The electrified vehicle 12 may also include a charging system 30 for charging the energy storage devices (e.g., the battery cells 32) of the traction battery pack 24. The charging system 30 may include charging components that are located both onboard the electrified vehicle 12 (e.g. vehicle charge port assembly, etc.) and external to the electrified vehicle 12 (e.g., electric vehicle supply equipment (EVSE), etc.). The charging system 30 can be connected to an external power source (e.g., a grid power source) for receiving and distributing power received from the external power source throughout the electrified vehicle 12.

The powertrain 10 depicted by FIG. 1 is highly schematic and is not intended to limit this disclosure. Various additional components could alternatively or additionally be employed by the powertrain 10 within the scope of this disclosure.

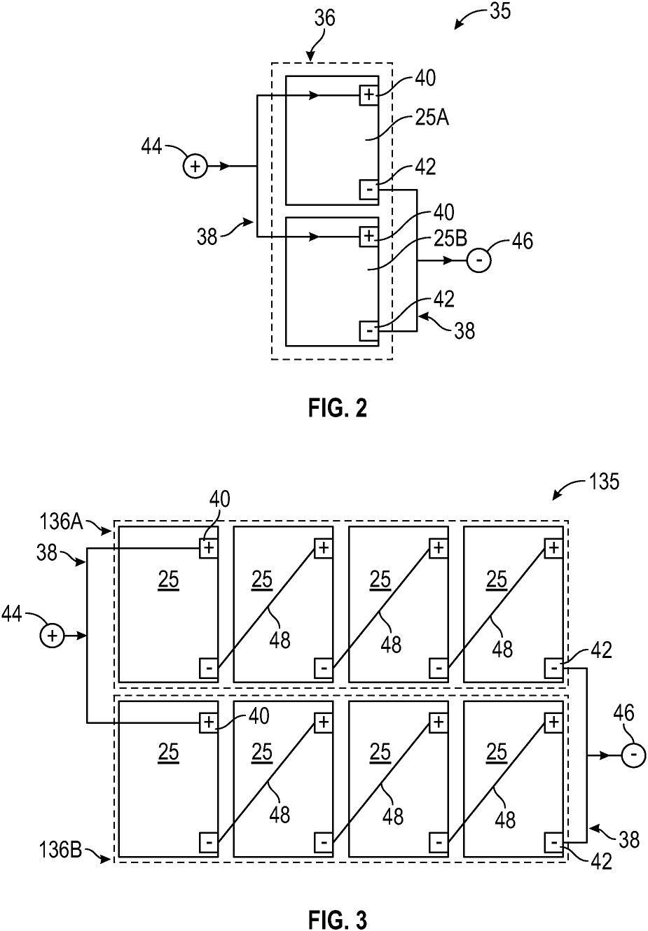

Referring to FIG. 2, with continued reference to FIG. 1, the traction battery pack 24 may include a battery system 35 that includes one or more strings 36 of battery arrays 25. In the illustrated embodiment, the string 36 includes a first battery array 25A and a second battery array 25B. However, the string 36 could include a greater amount of battery arrays, and in some embodiments, multiple battery strings 36 could be provided as part of the battery system 35 within the scope of this disclosure (see, e.g., the exemplary embodiment of FIG. 3).

Bus bar assemblies 38 may be utilized to electrically couple the first battery array 25A and the second battery array 25B of the string 36 in a parallel configuration. The bus bar assemblies 38 may be configured to carry a combined electrical current from the first and second battery arrays 25A, 25B.

In an embodiment, the bus bar assemblies 38 are components of an electrical distribution system (EDS) of the traction battery pack 24 that is designed for electrically distributing power to/from the traction battery pack 24. In the illustrated embodiment, one of the bus bar assemblies 38 electrically couples positive terminals 40 of the first and second battery arrays 25A, 25B, and another one of the bus bar assemblies 38 electrically couples negative terminals 42 of the first and second battery arrays 25A, 25B in order to achieve the parallel configuration. The bus bar assembly 38 that is connected to the positive terminals 40 may additionally connect to a main high voltage positive output point 44 of the battery system 35, and the bus bar assembly 38 that is connected to the negative terminals 42 may additionally connect to a main high voltage negative output point 46 of the battery system 35. Thus, power may be distributed to/from the parallelly connected battery arrays 25A, 25B.

In the illustrated embodiment of FIG. 2, the bus bar assemblies 38 are utilized to connect multiple battery arrays 24 in a parallel configuration. However, in other embodiments, the bus bar assemblies 38 could be utilized to electrically couple other components of the traction battery pack 24, such as a battery array and a bussed electrical center (BEC), for example. The bus bar assemblies 38 could be utilized to electrically couple any components of the traction battery pack 24 in parallel configurations.

FIG. 3 illustrates another exemplary battery system 135 that could be provided within a traction battery pack, such as the traction battery pack 24 of FIG. 1, for example. In this embodiment, the battery system 135 may include a first string 136A of battery arrays 25 and a second string 136B of battery arrays 25. The first string 136A and the second string 136B may each include four battery arrays 25 connected in series by multiple electrical connectors 48. However, a greater or fewer number of battery arrays 25 could be provided within each string 136A, 136B.

Bus bar assemblies 38 may be utilized to electrically couple the first string 136A and the second string 136B in a parallel configuration. The bus bar assemblies 38 may be configured to carry a combined electrical current from the first and second strings 136A, 136B.

One of the bus bar assemblies 38 may electrically couple positive terminals 40 of the first and second strings 136A, 136B, and another one of the bus bar assemblies 38 may electrically couple negative terminals 42 of the first and second strings 136A, 136B. The bus bar assembly 38 connected to the positive terminals 40 may additionally connect to a main high voltage positive output point 44 of the battery system 135, and the bus bar assembly 38 connected to the negative terminals 42 may additionally connect to a main high voltage negative output point 46 of the battery system 135. Thus, power may be distributed to/from the parallelly connected strings 136A, 136B.

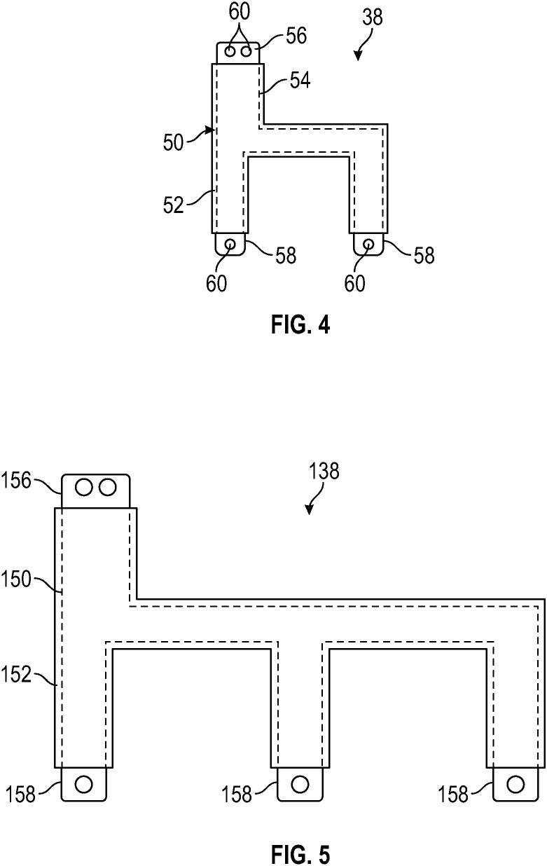

The bus bar assemblies 38 are shown schematically in FIGS. 2 and 3 but are illustrated in greater detail in FIG. 4. Each bus bar assembly 38 may include a bus bar 50 and a cover 52. The cover 52 may be configured to cover portions of the bus bar 50. The cover 52 may be overmolded about the bus bar 50, for example.

The bus bar 50 may be made of a metallic material, such as copper, for example. However, other conductive materials may also be utilized within the scope of this disclosure.

The cover 52 may be made of an insulating plastic material, such as a suitable thermoplastic or thermoset, for example. However, other insulating materials may also be utilized within the scope of this disclosure.

The bus bar 50 may include a unitary body 54. In an embodiment, the body 54 of the bus bar 50 embodies a lower case “h” shape. However, other shapes are also contemplated within the scope of this disclosure.

The body 54 of the bus bar 50 may include a combined electrical interface 56 and a pair of component electrical interfaces 58. The combined electrical interface 56 and the component electrical interfaces 58 are each at least partially exposed outside of the cover 52.

The combined electrical interface 56 is adapted for connection to one of the high voltage output points 44, 46 of the battery system 35/135, and the component electrical interfaces 58 are adapted for connection to one of the battery arrays 25 of the battery strings 36, 136. Therefore, each of the combined electrical interface 56 and the component electrical interfaces 58 may include one or more openings 60 that are adapted to receive a fastener (not shown) for securing the bus bar assemblies 38 to their respective traction battery pack electrical component.

The combined electrical interface 56 is configured to support the combined current received from each battery array 25 that is connected to the component electrical interfaces 58. Therefore, in an embodiment, the combined electrical interface 56 may include a cross-sectional area that is larger than the individual cross-sectional area associated with any of the component electrical interfaces 58.

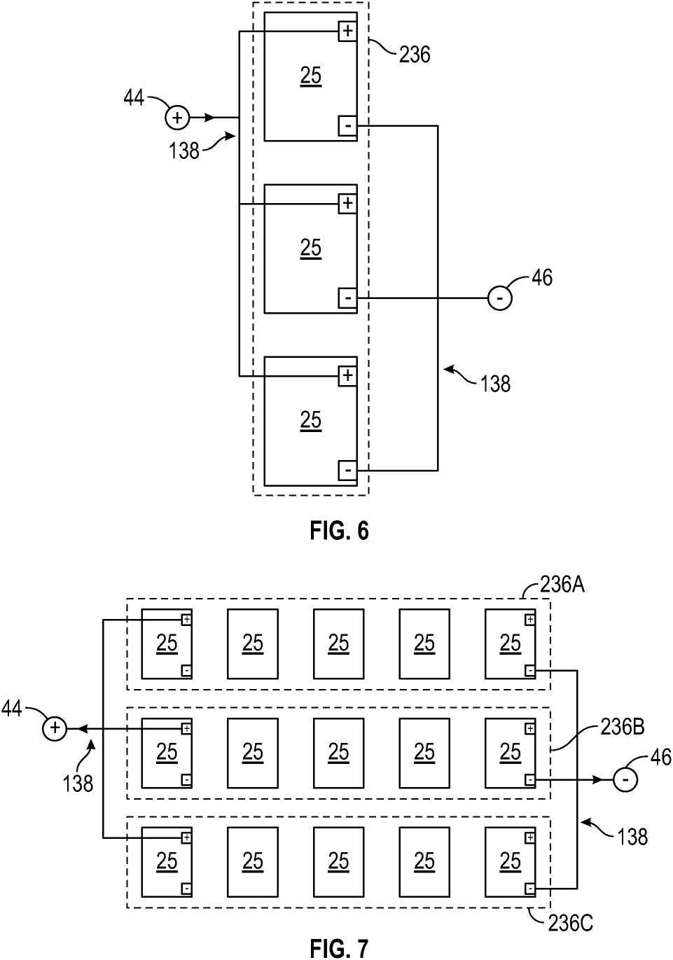

FIG. 5 illustrates another exemplary bus bar assembly 138. The bus bar assembly 138 is similar to the bus bar assembly 38 discussed above and includes a bus bar 150 and a cover 152. However, in this embodiment, the bus bar assembly 138 includes an additional component electrical interface 158 (e.g., for a total of three) and a combined electrical interface 156. Therefore, bus bar assemblies 138 may be utilized to electrically couple a string 236 of three battery arrays 25 in a parallel configuration (see, e.g., FIG. 6). In yet another embodiment, the bus bar assemblies 138 may be utilized to electrically couple three or more strings 236A, 236B, 236C of battery arrays 25 in a parallel configuration (see, e.g., FIG. 7).

In the illustrated embodiments, the bus bar assembly 38 is adapted to electrically couple two battery arrays 25 or strings of battery arrays in parallel, and the bus bar assembly 138 is adapted to electrically couple three battery arrays 25 or strings of battery arrays in parallel. However, the bus bar assemblies of this disclosure could be provided with any amount of component electrical interfaces for connecting as many battery arrays (or other traction battery electrical components) as desired in parallel configurations.

The exemplary bus bar assemblies of this disclosure are designed to enable parallel connection configurations between traction battery pack electrical components, thereby providing modularity and flexibility when electrically coupling battery arrays and/or other battery electrical components, for example. The proposed designs achieve lower heat generation and thus may reduce or completely eliminate the need for active bus bar cooling. The proposed designs may further optimize busbar sizing due to the division of current enabled by parallel connections.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
a first electrical component;
a second electrical component; and
a bus bar assembly configured to electrically couple the first and second electrical components in a parallel configuration,
wherein the bus bar assembly includes a bus bar having a first component electrical interface connected to the first electrical component, and a second component electrical interface connected to the second electrical component.

2. The battery pack as recited in claim 1, wherein the first electrical component is a first battery array and the second electrical component is a second battery array.

3. The battery pack as recited in claim 1, wherein the bus bar assembly is configured to electrically couple the first electrical component, the second electrical component, and a third electrical component in the parallel configuration.

4. The battery pack as recited in claim 3, wherein the bus bar includes a third component electrical interface connected to the third electrical component.

5. The battery pack as recited in claim 4, wherein the first, second, and third electrical components are battery arrays.

6. The battery pack as recited in claim 1, wherein the bus bar includes a combined electrical interface.

7. The battery pack as recited in claim 6, wherein the combined electrical interface includes a first cross-sectional area that is larger than a second cross-sectional area of the first component electrical interface or a third cross-sectional area of the second component electrical interface.

8. The battery pack as recited in claim 6, wherein the combined electrical interface is connected to a high voltage output point of the battery pack.

9. The battery pack as recited in claim 1, wherein the bus bar assembly includes a cover that at least partially covers the bus bar, and further wherein the first component electrical interface and the second component electrical interface are each at least partially exposed for making an electrical connection.

10. The battery pack as recited in claim 1, comprising a second bus bar assembly configured to electrically couple the first and second electrical components in the parallel configuration.

11. A battery pack, comprising:
a first string of battery arrays;
a second string of battery arrays; and
a bus bar assembly configured to electrically couple the first and second strings of battery arrays in a parallel configuration,
wherein the bus bar assembly includes a bus bar including a first component electrical interface connected to the first string of battery arrays and a second component electrical interface connected to the second string of battery arrays.

12. The battery pack as recited in claim 11, wherein the bus bar assembly includes a cover that at least partially covers the bus bar, and further wherein the first and second component electrical interfaces are at least partially exposed for making an electrical connection.

13. The battery pack as recited in claim 11, comprising a second bus bar assembly configured to electrically couple the first and second strings of battery arrays in the parallel configuration.

14. The battery pack as recited in claim 13, wherein the bus bar assembly is electrically coupled to positive terminals of the first and second strings of battery arrays and the second bus bar assembly is electrically coupled to negative terminals of the first and second strings of battery arrays.

15. The battery pack as recited in claim 14, wherein the bus bar assembly is further coupled to a high voltage positive output point of the battery pack and the second bus bar assembly is further coupled to a high voltage negative output point of the battery pack.

16. The battery pack as recited in claim 11, wherein each of the first and second strings of battery arrays includes a plurality of battery arrays connected together in a series configuration.

17. The battery pack as recited in claim 11, wherein the bus bar includes a combined electrical interface.

18. The battery pack as recited in claim 17, wherein the combined electrical interface includes a first cross-sectional area that is larger than a second cross-sectional area of the first component electrical interface or a third cross-sectional area of the second component electrical interface.

19. The battery pack as recited in claim 11, wherein the bus bar assembly is configured to electrically couple the first string of battery arrays, the second string of battery arrays, and a third string of battery arrays in the parallel configuration.

20. An electrified vehicle comprising the battery pack of claim 11.
